(19) United States
(12) Patent Application Publication
(10) Pub. No.: US 2024/0190549 A1
(43) Pub. Date: Jun. 13, 2024

(54) STEERING SYSTEM FOR A MARINE VESSEL

(71) Applicant: Volvo Penta Corporation, Göteborg (SE)

(72) Inventor: Joakim SÄLLBERG, Göteborg (SE)

(73) Assignee: VOLVO PENTA CORPORATION, Göteborg (SE)

(21) Appl. No.: 18/533,277

(22) Filed: Dec. 8, 2023

(30) Foreign Application Priority Data
Dec. 8, 2022 (EP) 22212315.0

(51) Int. Cl. B63H 20/12; B63H 25/42

(52) U.S. Cl. CPC B63H 20/12; B63H 25/42; B63H 2025/022

(57) ABSTRACT

A steering module for a marine vessel includes an IMU arranged to measure steering input by monitoring user gestures of a user using the steering module. The user gestures are interpreted as the steering input for steering the marine vessel. The steering module comprises a control unit arranged to initiate steering of the marine vessel according to the measured steering input.

### TECHNICAL FIELD

The disclosure relates generally to a steering module, a steering system, a computer system, a computer-implemented method, a marine vessel, a computer program product, a control system and a non-transitory computer-readable medium. In particular aspects, the disclosure relates to enabling steering of a marine vessel. The disclosure can be applied in marine vessels, such as boats, marine leisure crafts, jet skis, personal watercrafts, ships, tankers, freighters, submarines etc. The marine vessel may be referred to as a water vessel, waterborne vessel, water vehicle etc. Although the disclosure may be described with respect to a particular marine vessel, the disclosure is not restricted to any particular marine vessel.

### BACKGROUND

The steering system is an important system in a marine vessel. The steering system is used constantly and is important with respect to e.g. safe operation of the marine vessel. The steering system is used for steering the marine vessel, e.g. to change direction of the marine vessel while in motion. Failure or malfunction of the steering system should be avoided or at least reduced since it may lead to dangerous safety situations in the steering of the marine vessel.

In view of the above, there is a strive to develop further improved technology relating to steering of a marine vessel.

### SUMMARY

According to a first aspect of the disclosure, a steering module for a marine vessel is provided. The steering module comprises an inertial measurement unit (IMU) arranged to measure steering input by monitoring user gestures of a user using the steering module. The user gestures are interpreted as the steering input for steering the marine vessel. The steering module comprises a control unit arranged to initiate steering of the marine vessel according to the measured steering input.

The first aspect of the disclosure may seek to improve steering of a marine vessel. A technical benefit may include that steering of a marine vessel is improved. Since user gestures are interpreted as steering input for steering the marine vessel, it is intuitive for a user how to use the steering module for steering the marine vessel. The user only needs to show with his/hers gestures in order to steer the marine vessel, i.e. there is no need to learn non-intuitive buttons, reading a manual etc.

In some examples, the at least one steering module may be arranged to be in a connected steering mode or a wireless steering mode.

When it is in connected steering mode, it may be mechanically connected to the marine vessel, either directly or via some other module or system. A technical benefit of the connected steering mode may be that the steering module has a fixed place where it is located, and it is thereby not a large risk of the user not finding the steering module. The connected steering mode may provide a comfortable and traditional way of steering the marine vessel.

A technical benefit of the wireless steering mode may be that the steering module may be used “free flying”. The steering module may be located at any suitable location in the marine vessel and also in close proximity of the marine vessel when steering the marine vessel. The marine vessel may therefore be controlled from an arbitrary location on the marine vessel.

In some examples, the steering module may be arranged to provide information indicating an offboard location to a control system comprised in the marine vessel by means of a laser range measurement system comprised in the steering module when the steering module is pointed at the offboard location. The offboard location is offboard the marine vessel.

A technical benefit may include that the steering module comprises additional features, in addition to steering of the marine vessel. The information indicating the offboard location may be used to navigate the marine vessel to the offboard location, to measure a distance to the offboard location etc.

In some examples, the steering module may comprise a steering module compass and/or a steering module gyro arranged to align the steering input with a vessel compass and/or vessel gyro comprised in the marine vessel, such that a movement of the steering module may be interpreted in a coordinate system of the marine vessel, regardless of user orientation of the user using the steering module.

A technical benefit may be that the use of the steering module is easy and intuitive. A compass and/or a gyro provides high quality data, which increases the quality of the steering input and consequently also increases the quality of the steering of the marine vessel.

In some examples, the steering module may be arranged to be in a neutral state which causes the marine vessel to operate in Dynamic Position (DP) state. With the DP state, the position and heading of the marine vessel is automatically maintained using the marine vessel's own thrusters and propellers. When in DP state, the current position of the marine vessel may be maintained and/or a predetermined track may be followed by the marine vessel.

A technical benefit may be that it is only necessary to enter neutral state in order to initiate the marine vessel to operate in DP state. No other action is necessary. With DP state, no anchoring is needed to maintain the position of the marine vessel. It also provides improved maneuverability of the marine vessel.

In some examples, the steering modules may be a tiller, a handlebar, a joystick or a steering wheel.

A technical benefit may be that a plurality of different steering module may be used, which provides increased flexibility. The user may use the type of steering module that fits his/her preferences.

In some examples, the steering module may be arranged to be comprised in a steering system for the marine vessel together with a control console.

According to a second aspect of the disclosure, a steering system for a marine vessel is provided. The steering system comprises a control console arranged to be mechanically connected to the marine vessel. The control console comprises a steering module interface. The steering system comprises at least one steering module arranged to be connected to the control console via the steering module interface. The at least one steering module is arranged to be selected from a plurality of different steering module types. The steering module interface is arranged to connect steering modules of different types to the control console. The steering system is arranged to steer the marine vessel based on steering input obtained via the at least one steering module.

The second aspect of the disclosure may seek to improve steering of a marine vessel. A technical benefit may include that steering of a marine vessel is improved. Since the steering system comprises the control console and the steering module, i.e. it comprises at least two modules, it is considered to be modular. The modularity enables at least the steering module to be used in different marine vessels, i.e. the steering module is not arranged to only be used in one particular marine vessel. The control console remains the same regardless of the selected steering module. Thus, the steering system is flexible.

The second aspect of the disclosure may seek to provide an improved steering system for a marine vessel. A technical benefit may include that an improved steering system for a marine vessel is provided.

Technical benefits of the second aspect of the disclosure are largely analogous to the technical benefits of the first aspect of the disclosure. It shall also be noted that all examples of the first aspect of the disclosure are applicable to and combinable with all examples of the second aspect of the disclosure, and vice versa.

A technical benefit of the selection from a plurality of steering modules is that it provides flexibility with respect to which steering module to connect to the control console. The steering modules may be of different types. A steering module mapping with a user's preferences may be selected and connected to the control console via the steering module interface. A steering module mapping with a certain type of route may be selected and connected to the control console. The steering module interface may be seen as universal when a plurality of steering modules may be connected to it.

In some examples, the at least one steering module may be mechanically connected to the control console via the steering module interface when the at least one steering module is in a connected steering mode. The at least one steering module may be wirelessly connected to the control console via the steering module interface when the at least one steering module is in a wireless steering mode.

A technical benefit of the connected steering mode may be that the steering module may have a fixed place where it is located, and it is thereby not a large risk of the user not finding the steering module. Connecting the steering module to a control console may provide a comfortable and traditional way of steering the marine vessel.

A technical benefit of the wireless steering mode may be that the steering module may be used “free flying”. The steering module may be located at any suitable location in the marine vessel and also in close proximity of the marine vessel when steering the marine vessel. The marine vessel may therefore be controlled from an arbitrary location on the marine vessel.

In some examples, the steering system may be arranged to steer the marine vessel based on the steering input by providing control commands to a least one of a rudder system and/or a propulsion system comprised in the marine vessel.

A technical benefit of the rudder system and/or the propulsion system may include that steering of the marine vessel is improved. The rudder system enables the marine vessel to be steered in different directions. The propulsion system enables the marine vessel to move through water.

In some examples, a force sensor may be connected to a rudder system comprised in the marine vessel and arranged to measure a rudder force. An actuator may be arranged to apply force feedback to the at least one steering module in dependence of the measured rudder force.

A technical benefit may be that the user holding the steering module in his/her hands may feel a force representing the measured rudder force. It provides feedback to the user holding the steering module of his/hers control commands such that it is easy to get a confirmation that the commands are applied.

In some examples, the control console may be arranged to be tilted laterally with respect to a travelling direction of the marine vessel.

If the marine vessel is to take a right turn, then the control console may be tilted to right. Thus, the control console may be tilted in the same direction as the travel direction. A technical benefit may be that steering of the marine vessel is easy and intuitive.

In some examples, the different types of steering modules may comprise one or more of: a tiller, a handlebar, a joystick and a steering wheel.

A technical benefit may include that the steering system is not limited to any particular steering module. It provides flexibility with respect to which steering module to connect to the control console. Different types of steering modules may have different features, users may have different preferences of steering module types, different types of steering modules may be suitable for different types of travels etc.

According to a third aspect of the disclosure, a computer system comprising a processor device is provided. The computer system is configured to obtain information indicating measured steering input which has been measured by an IMU by monitoring user gestures of a user using the steering module. The user gestures are interpreted as the steering input for steering the marine vessel. The computer system is configured to initiate steering of the marine vessel according to the information indicating the measured steering input, thereby steering the marine vessel according to the user gestures.

The third aspect of the disclosure may seek to improve steering of marine vessel. A technical benefit may include that steering of a marine vessel is improved. Technical benefits of the third second aspect of the disclosure are largely analogous to the technical benefits of the first and second aspects of the disclosure. It shall also be noted that all examples of the first and second aspects of the disclosure are applicable to and combinable with all examples of the third aspect of the disclosure, and vice versa.

According to a fourth aspect of the disclosure, a computer-implemented method is provided. The computer-implemented method comprises to obtain, by a processor device of a computer system, information indicating steering input which has been measured by an IMU by monitoring user gestures of a user using a steering module. The user gestures are interpreted as the steering input for steering the marine vessel. The method comprises to initiate, by the processor device, steering of the marine vessel according to the information indicating the steering input, thereby steering the marine vessel according to the user gestures.

The fourth aspect of the disclosure may seek to improve steering of marine vessel. A technical benefit may include that steering of a marine vessel is improved. Technical benefits of the fourth second aspect of the disclosure are largely analogous to the technical benefits of the first, second and third aspects of the disclosure. It shall also be noted that all examples of the first, second and third aspects of the disclosure are applicable to and combinable with all examples of the fourth aspect of the disclosure, and vice versa.

In some examples, the method may comprise to obtain, by the processor device, information indicating that that the steering module is pointed at an offboard location. The method may comprise to initiate, by the processor device, steering of the marine vessel towards the offboard location and/or measuring a distance to the offboard location. The offboard location is offboard the marine vessel.

In some examples, the method may comprise to determine, by the processor device, that the steering module is in neutral state, and to initiate, by the processor device, the marine vessel to operate in dynamic position state when the steering module is in neutral state.

According to a fifth aspect of the disclosure, a marine vessel is provided. The marine vessel comprises the steering system of the second aspect.

The fifth aspect of the disclosure may seek to improve steering of marine vessel. A technical benefit may include that steering of a marine vessel is improved. Technical benefits of the fifth second aspect of the disclosure are largely analogous to the technical benefits of the first, second, third and fourth aspects of the disclosure. It shall also be noted that all examples of the first, second, third and fourth aspects of the disclosure are applicable to and combinable with all examples of the fifth aspect of the disclosure, and vice versa.

According to a sixth aspect of the disclosure, a marine vessel is provided. The marine vessel comprises the steering module of the first aspect.

The sixth aspect of the disclosure may seek to improve steering of marine vessel. A technical benefit may include that steering of a marine vessel is improved. Technical benefits of the sixth second aspect of the disclosure are largely analogous to the technical benefits of the first, second, third, fourth and fifth aspects of the disclosure. It shall also be noted that all examples of the first, second, third, fourth and fifth aspects of the disclosure are applicable to and combinable with all examples of the sixth aspect of the disclosure, and vice versa.

According to a seventh aspect of the disclosure, a computer program product is provided. The computer program product comprises program code for performing, when executed by a processor device, the method of the fourth aspect.

The seventh aspect of the disclosure may seek to improve steering of marine vessel. A technical benefit may include that steering of a marine vessel is improved. Technical benefits of the seventh second aspect of the disclosure are largely analogous to the technical benefits of the first, second, third, fourth, fifth and sixth aspects of the disclosure. It shall also be noted that all examples of the first, second, third, fourth, fifth and sixth aspects of the disclosure are applicable to and combinable with all examples of the seventh aspect of the disclosure, and vice versa.

According to an eight aspect of the disclosure, a control system is provided. The control system comprises one or more control units configured to perform the method of the fourth aspect.

The eight aspect of the disclosure may seek to improve steering of marine vessel. A technical benefit may include that steering of a marine vessel is improved. Technical benefits of the eight second aspect of the disclosure are largely analogous to the technical benefits of the first, second, third, fourth, fifth, sixth and seventh aspects of the disclosure. It shall also be noted that all examples of the first, second, third, fourth, fifth, sixth and seventh aspects of the disclosure are applicable to and combinable with all examples of the eight aspect of the disclosure, and vice versa.

According to a ninth aspect of the disclosure, a non-transitory computer-readable storage medium is provided. The non-transitory computer-readable storage medium comprises instructions, which when executed by a processor device, cause the processor device to perform the method of the fourth aspect.

The ninth aspect of the disclosure may seek to improve steering of marine vessel. A technical benefit may include that steering of a marine vessel is improved. Technical benefits of the ninth second aspect of the disclosure are largely analogous to the technical benefits of the first, second, third, fourth, fifth, sixth, seventh and eight aspects of the disclosure. It shall also be noted that all examples of the first, second, third, fourth, fifth, sixth, seventh and eight aspects of the disclosure are applicable to and combinable with all examples of the ninth aspect of the disclosure, and vice versa.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is an exemplary drawing illustrating a marine vessel, according to one example.

FIG. 2 is an exemplary drawing illustrating a steering system, according to one example.

FIG. 3 is an exemplary drawing illustrating a marine vessel comprising a steering system, according to one example.

FIG. 4 is an exemplary drawing illustrating a marine vessel comprising a steering system, according to one example.

FIG. 5 is an exemplary drawing illustrating steering module and a marine vessel, according to one example.

FIG. 6 is an exemplary flow chart illustrating a method, according to one example.

FIG. 7 is a schematic diagram of an exemplary computer system for implementing examples disclosed herein, according to one example.

### DETAILED DESCRIPTION

Aspects set forth below represent the necessary information to enable those skilled in the art to practice the disclosure.

The steering system is an important system in a marine vessel. The steering system is used constantly and is important with respect to safe and important operation of the marine vessel. The steering system is used for steering the marine vessel, e.g. to change direction of the marine vessel while in motion. Failure or malfunction of the steering system should be avoided or at least reduced since they may lead to dangerous safety situations in the steering of the marine vessel. Therefore, there is a strive to develop further improved technology relating to steering systems for a marine vessel.

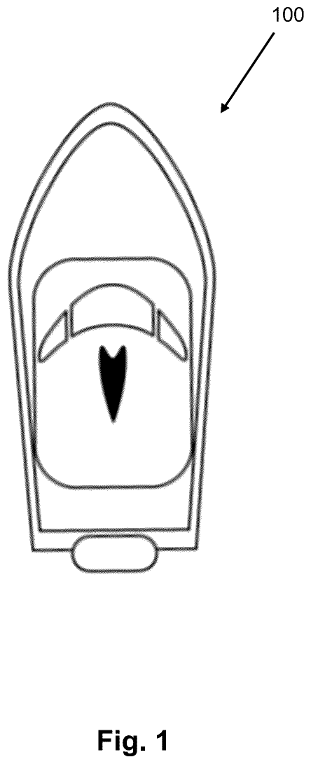

FIG. 1 is an is an exemplary drawing illustrating a marine vessel 100, according to one example.

The marine vessel 100 may be any marine vessel 100 such as boat, marine leisure craft, jet ski, personal watercraft, ship, tanker, freighter, submarine etc. The marine vessel may be referred to as a water vessel, waterborne vessel, water vehicle etc. Although the disclosure may be described with respect to a particular marine vessel, the disclosure is not restricted to any particular marine vessel.

The marine vessel 100 may be at least partly electrically driven, it may be completely electrically driven, it may be completely driven using a combustion engine, it may be partly electrical driven and partly driven using a combustion engine etc.

The marine vessel 100 is steered by a user. Steering the marine vessel 100 may be referred to as operating the marine vessel 100, driving the marine vessel 100 etc.

The marine vessel 100 comprises a rudder system and a propulsion system (not illustrated in FIG. 1) which participates in the steering of the marine vessel 100. Note that the marine vessel 10 may comprise other systems and units which may participate in the steering of the marine vessel 100, but that they are not mentioned herein for the sake of simplicity.

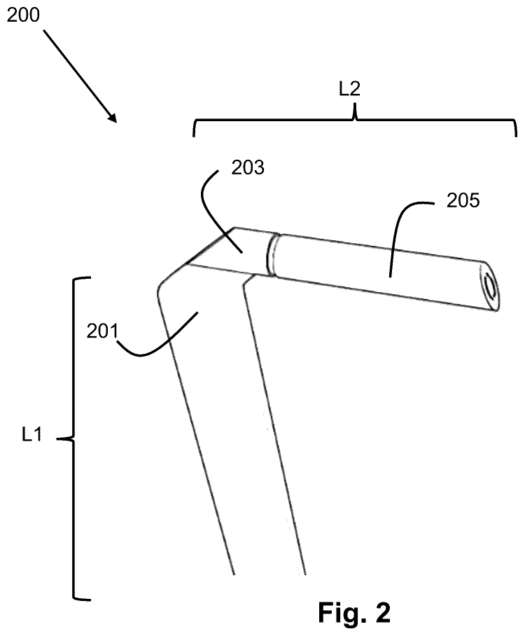

FIG. 2 is an exemplary drawing illustrating a steering system 200, according to one example. The steering system 200 is arranged to steer the marine vessel 100 based on the steering input. The user gestures of a user using the steering system 200 are interpreted as the steering input for steering the marine vessel 100.

The steering system 200 comprises a control console 201 arranged to be mechanically connected to the marine vessel 100. The control console 201 may be arranged to be connected to the marine vessel 100 in a first end, e.g. to the deck of the marine vessel 100. The control console 201 may be referred to as a docking unit, a base unit etc.

The control console 201 comprises a steering module interface 203.

The steering system 200 comprises at least one steering module 205 arranged to be connected to the control console 201 via the steering module interface 203. The steering system 200 is be arranged to steer the marine vessel 100 based on the steering input obtained via the at least one steering module 205. The steering system 200 may be arranged to steer the marine vessel 100 based on the steering input by providing control commands to a least one of a rudder system and/or a propulsion system comprised in the marine vessel 100.

A force sensor may be connected to a rudder system comprised in the marine vessel 100 and arranged to measure a rudder force. An actuator may be arranged to apply force feedback to the at least one steering module 205 in dependence of the measured rudder force.

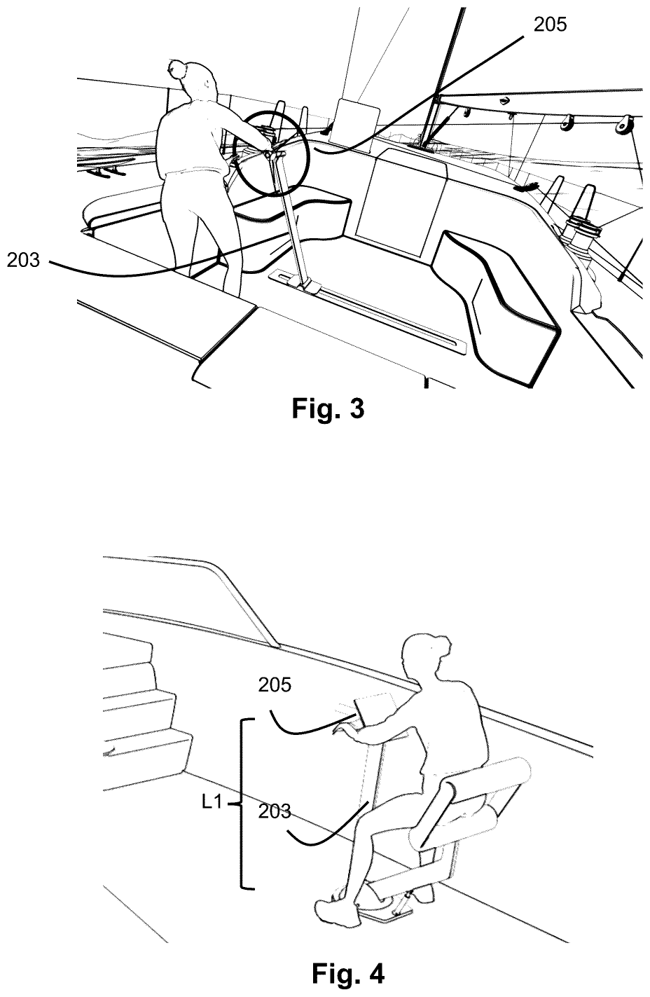

The at least one steering module 205 is arranged to be selected from a plurality of different steering module types. The different types of steering modules 205 may comprise one or more of: a tiller, a handlebar, a joystick and a steering wheel. FIG. 2 illustrates the example of the joystick, FIG. 3 is an exemplary drawing illustrating a steering wheel, and FIG. 4 is an exemplary drawing illustrating a handlebar.

The at least one steering module 205 may be selected by a user, e.g. a driver of the marine vessel 100, an operator of the marine vessel 100 or by any other suitable person.

The at least one steering module 205 may be selected by the marine vessel 100 or by a control system comprised in the marine vessel 100. The marine vessel 100 may comprise information indicating available and selectable steering modules 205, which together with information indicating a predetermined route to be travelled by the marine vessel, weather information, information about the marine vessel 100 such as type of vessel, weight, length etc., for basis for the selection of steering module 205.

The steering module interface 203 is arranged to connect steering modules 205 of the different types to the control console 201.

The steering module interface 203 may be described as an interface or adapter for connecting to the at least one steering module 205, i.e. the steering module interface 203 is located between the control console 201 and the at least one steering module 205. The steering module interface 203 may be comprised in the control console 201 or arranged to be connected to the control console 201. The steering module interface 203 may be a uniform interface since different types of steering modules 205 may be connected to it.

As exemplified in FIGS 2-4, the steering module interface 203 may be located in a second end of the control console 201. The second end is on the opposite side of the control console 201 compared to the first end which is connected to the marine vessel 100.

The steering module interface 203 may be arranged to mechanically connect the at least one steering module 205 to the control console 201, or to wirelessly connect the at least one steering module 205 to the control console 201. Consequently, the at least one steering module 205 is arranged to operate in wireless steering mode or connected steering mode. The at least one steering module 205 may or may not be connected to the control console 201 when in wireless steering mode, i.e. the at least one steering module 205 may function without any connection to the control console 201.

In order to be arranged to physically connect the at least one steering module 205 to the control console 201, the steering module interface 203 may comprise a suitable connector. For example, the steering module interface 203 may comprise a female unit in which a male unit of the at least one steering module 205 is arranged to be inserted. The steering module interface 203 may be arranged to connect to the at least one steering module 205 using magnets, screws, bolts, or any other suitable connector.

The steering module interface 203 may be arranged such that the at least one steering module 205 may be attached to and detached from the control console 201 multiple times. The steering module interface 203 may be arranged such that the at least one steering module 205 may be attached to and detached from the control console 201 during steering of the marine vessel 100. When the marine vessel 100 is being steered with the at least one steering module 205 in connected steering mode, and then the at least one steering module 205 is mechanically detached from the control console, then the at least one steering module 205 changes from connected steering mode to wireless steering mode. Similarly, when the marine vessel 100 is being steered with the at least one steering module 205 in wireless steering mode, and then the at least one steering module 205 is mechanically connected to the control console, then the at least one steering module 205 changes from wireless steering mode to connected steering mode. Thus, the steering mode of the at least one steering module 205 may change during the steering operation. The mechanical removal of the at least one steering module 205 from the control console 201 may be considered as a trigger for the change of the steering mode, i.e. change between wireless and connected steering modes. The user of the at least one steering module 205 does not have to push any dedicated steering mode change button.

In order to be arranged to wirelessly connect the at least one steering module 205 to the control console 201, the steering module interface 203 may comprise a wireless receiver and the at least one steering module 205 may comprise a wireless transmitter, or the steering module interface 203 may comprise a wireless transceiver and the at least one steering module 205 may comprise a wireless transceiver. The wireless connection may use any suitable communication technology, e.g. Bluetooth, Wi-Fi, mobile communication etc.

The control console 201 may or may not comprise any intelligence, i.e. it may or may not comprise a processor or processing system. When the at least one steering module 205 is mechanically connected to the control console 201, the control console 201 may be arranged to function as only a holder or rack for the at least one steering module 205 and without having its own processing capacity. When the at least one steering module 205 is mechanically connected to the control console 201, the control console 201 may, in addition to be a holder or rack for the at least one steering module 205, it may have its own processing capacity.

When the at least one steering module 205 is wirelessly connected to the control console 201 via the steering module interface 203, the control console 201 may have its own processing capacity in order to receive the wireless communication from the at least one steering module 205 and providing the communication further to other systems of the marine vessel 100 e.g. the rudder system, the propulsion system etc. The control console 201 may be arranged to analyze and process the communication from the at least one steering module 205 before providing it further to other systems of the marine vessel 100. As mentioned earlier, the at least one steering module 205 may be arranged to enable steering of the marine vessel 100 without any connection to a control console 201, i.e. the at least one steering module 205 may be arranged to communicate directly with the rudder system and/or propulsion system. Consequently, the marine vessel 100 may not necessarily comprise the control console 201.

As mentioned earlier, the steering system 200 may be arranged to steer the marine vessel 100 based on the steering input by providing control commands to a least one of a rudder system and/or a propulsion system comprised in the marine vessel 100. The steering input, which is obtained via the at least one steering module 205, may be processed and converted into a control command by the at least one steering module 205 or by the control console 201, when the control console 201 comprises a processor, or the processing and conversion into control commands may be partly performed by the at least one steering module 205 and partly by the control console 201.

The control console 201 may have a pole shape, a box shape, or any other suitable shape. The pole shape is exemplified in FIG. 3 and FIG. 4. The control console 201 may have a length L1 (see FIGS. 2 and 3 where the length L1 is indicated) such that is comfortable for the user standing on the deck of the marine vessel 100 or sitting on a chair to hold his/her hand(s) on the at least one steering module 205, as illustrated in FIG. 3 and FIG. 4. For example, the length L1 of the control console 201 may extend from the deck of the marine vessel 100 to an average waist location of a person. The length L1 of the control console 201 may be for example in a range of 0.1-1 meters, with some tolerance. Instead of being connected to the deck of the marine vessel 100, the control console 201 may be connected to a dashboard or cockpit of the marine vessel 100, and consequently, the length L1 of the control console 201 may be shorter than when connected to the deck, for example in the range 5-20 cm, with some tolerance. The length L1 of the control console 201 may be adjustable such that a user may adjust it to the length L1 that he/she prefers. In order to be adjustable, the control console 201 may be a telescopic pole, it may comprise removable sub parts that easily can be removed in order to obtain the wanted length L1 of the control console 201.

The length L1 of the control console 201 may be longer than the length L2 (see FIG. 2) of the steering module 205. The length L1 of the control console 201 may be for example twice the length L2 of the steering module 205, it may be three times the length L2 of the steering module 205 or any other suitable length L1.

The control console 201 may be arranged to be connected to the marine vessel 100 in a first end and in a vertical direction with respect to the deck of the marine vessel 100, as exemplified in FIG. 3 and FIG. 4. The control console 201 may be arranged to be connected to the at least one steering module 205 via the steering module interface 203 in a second end of the control console 201. Thus, the connection to the deck and the at least one steering module 205 are in opposite ends of the control console 201.

The control console 201 may be arranged to be tilted laterally with respect to a travelling direction of the marine vessel 100. This is exemplified in FIG. 3 where the at least one steering module 205 is exemplified with a steering wheel. Thus, the control console 201 may be adjusted to a desired angle in order to obtain a steering position for the user which is ergonomically advantageous.

The at least one steering module 205 comprises an IMU arranged to measure steering input by monitoring user gestures of a user using the steering module 205. The IMU may be any suitable type, for example a six-axis IMU. The user gestures are interpreted as the steering input for steering the marine vessel 100. For example, when the user moves the at least one steering module 205 to the right, then this is interpreted as steering the marine vessel 100 to the right.

When the at least one steering module 205 is in wireless steering mode, activation of a steering button may be necessary such that not all user gestures are interpreted as steering input. For example, it may not be desirable that moving the at least one steering module 205 from one storage place to another storage place being interpreted as a steering input.

The at least one steering module 205 may be arranged to be floating when located in water, which may be advantageous in case the at least one steering module 205 is lost in the water. The at least one steering module 205 may comprise a tracking system such that the position of the at least one steering module 205 may be tracked if it is lost in water, if it is stolen, if the user does not remember where it is located etc. The position of the at least on steering module 205 may be tracked from for example a mobile phone, a table computer, a navigation system onboard the marine vessel 100, a control system onboard the marine vessel 100 etc. The at least one steering module 205 may be arranged to comprise or to be connected to a dead man's switch such that the at least one steering module 205 is deactivated if the user loses the at least one steering module for some reason.

The at least one steering module 205 may be arranged to provide an alarm when the at least one steering module 205 is in the water. The alarm may be an audio alarm, a visual alarm in the form of a blinking light or any other suitable alarm. This may be advantageous in case the at least one steering module is lost in the water.

The at least one steering module 205 comprises a control unit arranged to initiate steering of the marine vessel 100 according to the measured steering input. The control unit may initiate the steering by sending control commands to at least one of a rudder system and/or a propulsion system comprised in the marine vessel 100. The control commands maybe created by the control unit based on the steering input.

The at least one steering module 205 may be arranged to provide information indicating an offboard location to a control system comprised in the marine vessel 100 by means of a laser range measurement system comprised in the steering module 205 when the steering module 205 is pointed at the offboard location. The offboard location is offboard the marine vessel 100. The offboard location may be for example a destination to which the marine vessel 100 should travel. The control system may be for example a navigation system. The steering module 205 may comprise a bearing measurement system, which together with the laser range measurement system may be arranged to provide information indicating the offboard location, e.g. a distance to the offboard location, position coordinates of the offboard location etc.

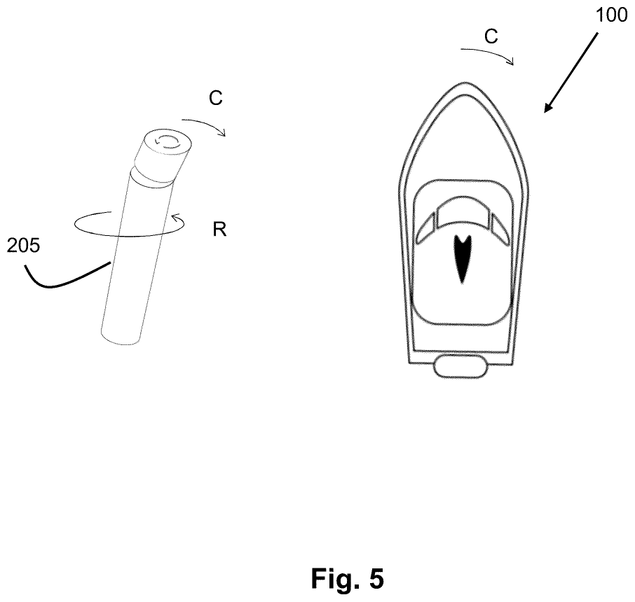

The at least one steering module 205 may comprise a steering module compass and/or a steering module gyro arranged to align the steering input with a vessel compass and/or a vessel gyro comprised in the marine vessel 100, such that a movement of the steering module 205 is interpreted in a coordinate system of the marine vessel 100, regardless of user orientation of the user using the steering module 205. This is exemplified in FIG. 5. Regardless of how the at least one steering module 205 is rotated about its own vertical axis R, a steering input C will always result in the same behavior by the marine vessel 100.

The at least one steering module 205 may be in forward state, neutral state or revers state. The neutral state may cause the marine vessel 100 to operate in DP state. With the DP state, the position and heading of the marine vessel 100 is automatically maintained using the marine vessel's own thrusters and propellers. When in DP state, the current position of the marine vessel 100 may be maintained and/or that a predetermined track is followed by the marine vessel 100. It is only necessary to enter neutral state in order to initiate the marine vessel to operate in DP state. With DP state, no anchoring is needed to maintain the position of the marine vessel 100. It also provides improved maneuverability of the marine vessel 100.

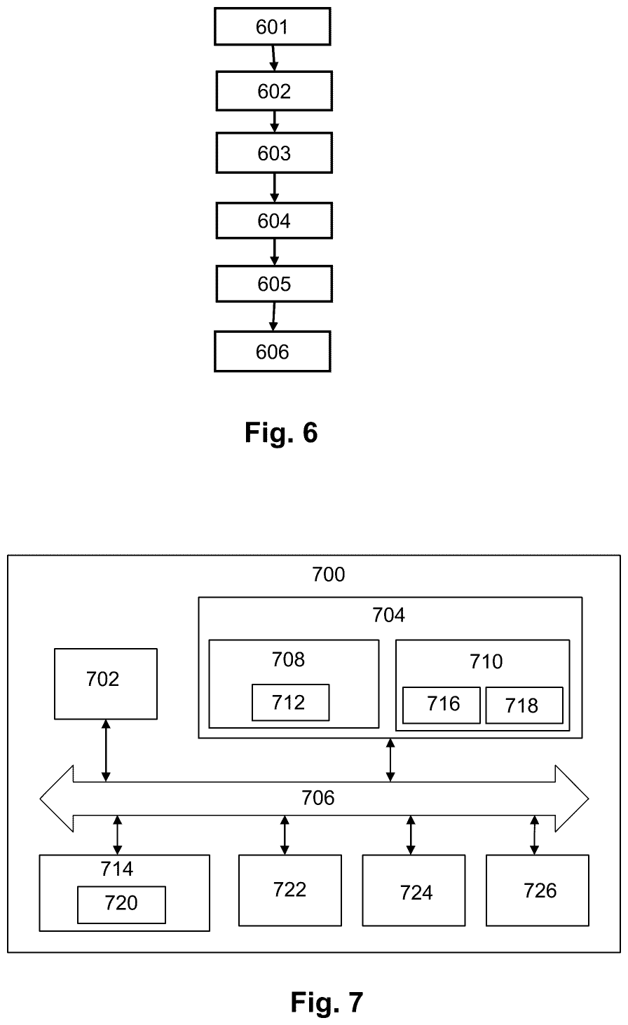

FIG. 6 is a flow chart illustrating a method, e.g. a computer-implemented method. The method may be performed by a processor device of a computer system. The method may be performed by a control system or a control unit. The control system may comprise one or more control units. The control unit may be a processor device, or it may be comprised in a processor device. The method may be performed by the at least one steering module 205, or a processor or a control unit comprised in the at least one steering module 205. The method comprises at least one of the following steps, which steps may be performed in any suitable order than described below:

Step 601: Obtaining, by a processor device of a computer system, information indicating steering input which has been measured by an IMU, by monitoring user gestures of a user using a steering module 205. The user gestures are interpreted as the steering input for steering the marine vessel 100. The IMU may be a six-axis IMU.

Step 602: Initiating, by the processor device, steering of the marine vessel 100 according to the information indicating the steering input, thereby steering the marine vessel 100 according to the user gestures. Initiating the steering of the marine vessel 100 may comprise to create and provide control commands to at least one of the rudder system and/or the propulsion system of the marine vessel 100.

Step 603: Obtaining, by the processor device, information indicating that that the steering module 205 is pointed at an offboard location. Step 603 may be an optional step. The information may be obtained from a laser range measurement system comprised in the at least one steering module 205. The steering module 205 may comprise a bearing measurement system, which together with the laser range measurement system may be arranged to provide information indicating the offboard location.

Step 604: Initiating, by the processor device, steering of the marine vessel 100 towards the offboard location and/or measuring a distance to the offboard location. The offboard location is offboard the marine vessel 100. Step 604 may be an optional step. This may be performed by sending information to a navigation system comprised in the marine vessel 100 which is arranged to create route for the marine vessel 100 to reach the offboard location.

Step 605: Determining, by the processor device, that the steering module 205 is in neutral state. Step 605 may be an optional step.

Step 606: Initiating, by the processor device, the marine vessel 100 to operate in DP state when the steering module is in neutral state. Step 606 may be an optional step. This may comprise to send control commands to the rudder system of the marine vessel 100 to operate in DP state.

A computer system comprising a processor device configured to:
obtain information indicating measured steering input which has been measured by an IMU by monitoring user gestures of a user using the steering module 205, wherein the user gestures are interpreted as the steering input for steering the marine vessel 100, and to
initiate steering of the marine vessel 100 according to the information indicating the measured steering input, thereby steering the marine vessel 100 according to the user gestures.

The marine vessel 100 comprises the steering system 200 as described herein.

The marine vessel 100 comprising at least one steering module 205 described herein.

A computer program product comprises program code for performing, when executed by a processor device, the method described herein, e.g. as exemplified in FIG. 6.

A control system comprises one or more control units configured to perform the method described herein, e.g. as exemplified in FIG. 6.

A non-transitory computer-readable storage medium comprises instructions, which when executed by a processor device, cause the processor device to perform the method described herein, e.g. as exemplified in FIG. 6.

Summarized, the disclosure provides a modular steering system 200 for a marine vessel 100. The modular steering system 200 is versatile and arranged to adapt to several uses cases, where the uses cases may comprise different types of steering modules 205.

The modular steering system 200 comprises a control console 201 with a steering module interface 203, and a selection of steering modules 205. The control console 201 is arranged to interface with the steering module 205 and to control the marine vessel 100 based on steering input received from a user via the attached steering module 205.

The different types of steering modules 205 comprise a tiller, handlebar, a joystick, and a steering wheel.

The at least one steering module 205 is arranged to be removed from the control console 201 and be used in wireless steering mode, where inertial measurement units and/or gyros detect user input gestures.

The control console 201 may be arranged to be tilted laterally with respect to a travelling direction of the marine vessel 100, as exemplified in FIG. 3.

The control console 201 may comprises a communication interface arranged to communicate control commands to a rudder system and/or a propulsion system of the marine vessel 100.

A force sensor may be connected to the rudder system of the marine vessel 100 and arranged to measure rudder force. An actuator may apply force feedback to the steering module 205 in dependence of the measured rudder force.

The same steering module 205 may be used on many different types of marine vessels 100, which allows for improvements in cost efficiency. FIG. 3 illustrates an example of a sailing boat and FIG. 4 illustrates an example of a motorboat. A user may select a preferred steering module 205 and use it for steering a marine vessel 100.

The digital control interface to the actuators on the marine vessel 100 may remain the same regardless of the selected steering module 205.

The steering module 205, e.g., the steering wheel or the joystick, may be removed from the control console 201 and used “free-flying”.

The steering module 205 may be used, when in wireless steering mode, from arbitrary locations on the marine vessel 100.

The steering module 205 is arranged to control steering of the marine vessel 100. The steering module 205 comprising an IMU configured to measure user input by monitoring user gestures, and a control unit arranged to relay the measured user input to a steering and propulsion system of the marine vessel 100. The IMU may be a six-axis IMU.

The steering module 205 may be arranged to be attached to a control console 201 and used as a stationary tiller.

The steering module 205 may comprises a laser range measurement system and/or an electronic bearing measurement system, whereby a user may designate an offboard location and communicate this to a vessel control system by pointing the laser range finder at the location.

The steering module 205 may comprise an internal compass and/or internal gyro arranged to align control commands with an on-board vessel compass and/or vessel gyro of the marine vessel 100, such that a movement of the steering module 205 is interpreted in the coordinate system of the marine vessel 100, regardless of user orientation.

The steering module 205 may be carried by the user and the marine vessel 100 may therefore be controlled from an arbitrary location on the marine vessel 100, and also offboard the marine vessel 100, e.g. from the quay.

The steering module 205 may be optionally comprised in a steering system 200 which may also comprise the control console 201, to which the steering module 205 may be attached and used as tiller. The control console 201 which receives the steering module 205 in tiller mode need not comprise any intelligence, since sensors of the steering module 205 are sufficient to emulate tiller mode control.

The steering module 205 may comprises an electronic compass, possibly complemented by a gyro or other sensor system, which may be arranged to determine an orientation of the steering module 205 in relation to the longitudinal axis of the marine vessel 100. This way a tilt of the steering module 205 in one direction may be interpreted in the coordinate system of the marine vessel 100, regardless off the orientation of the user of the steering module 205.

FIG. 7 is a schematic diagram of a computer system 700 for implementing examples disclosed herein. The computer system 700 is adapted to execute instructions from a computer-readable medium to perform these and/or any of the functions or processing described herein. The computer system 700 may be connected (e.g., networked) to other machines in a LAN, an intranet, an extranet, or the Internet. While only a single device is illustrated, the computer system 700 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 700 may comprise at least one computing device or electronic device capable of including firmware, hardware, and/or executing software instructions to implement the functionality described herein. The computer system 700 may include a processor device 702 (may also be referred to as a control unit), a memory 704, and a system bus 706. The computer system 700 may include at least one computing device having the processor device 702. The system bus 706 provides an interface for system components including, but not limited to, the memory 704 and the processor device 702. The processor device 702 may include any number of hardware components for conducting data or signal processing or for executing computer code stored in memory 704. The processor device 702 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 706 may be any of several types of bus structures that may further interconnect to a memory bus (with or without a memory controller), a peripheral bus, and/or a local bus using any of a variety of bus architectures. The memory 704 may be one or more devices for storing data and/or computer code for completing or facilitating methods described herein. The memory 704 may include database components, object code components, script components, or other types of information structure for supporting the various activities herein. Any distributed or local memory device may be utilized with the systems and methods of this description. The memory 704 may be communicably connected to the processor device 702 (e.g., via a circuit or any other wired, wireless, or network connection) and may include computer code for executing one or more processes described herein. The memory 704 may include non-volatile memory 708 (e.g., read-only memory (ROM), erasable programmable read-only memory (EPROM), electrically erasable programmable read-only memory (EEPROM), etc.), and volatile memory 710 (e.g., random-access memory (RAM)), or any other medium which can be used to carry or store desired program code in the form of machine-executable instructions or data structures and which can be accessed by a computer or other machine with a processor device 702. A basic input/output system (BIOS) 712 may be stored in the non-volatile memory 708 and can include the basic routines that help to transfer information between elements within the computer system 700.

The computer system 700 may further include or be coupled to a non-transitory computer-readable storage medium such as the storage device 714, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 714 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 714 and/or in the volatile memory 710, which may include an operating system 716 and/or one or more program modules 718. All or a portion of the examples disclosed herein may be implemented as a computer program product 720 stored on a transitory or non-transitory computer-usable or computer-readable storage medium (e.g., single medium or multiple media), such as the storage device 714, which includes complex programming instructions (e.g., complex computer-readable program code) to cause the processor device 702 to carry out the steps described herein. Thus, the computer-readable program code can comprise software instructions for implementing the functionality of the examples described herein when executed by the processor device 702. The processor device 702 may serve as a controller or control system for the computer system 700 that is to implement the functionality described herein.

The computer system 700 also may include an input device interface 722 (e.g., input device interface and/or output device interface). The input device interface 722 may be configured to receive input and selections to be communicated to the computer system XX00 when executing instructions, such as from a keyboard, mouse, touch-sensitive surface, etc. Such input devices may be connected to the processor device 702 through the input device interface 722 coupled to the system bus 706 but can be connected through other interfaces such as a parallel port, an Institute of Electrical and Electronic Engineers (IEEE) 1394 serial port, a Universal Serial Bus (USB) port, an IR interface, and the like. The computer system 700 may include an output device interface 724 configured to forward output, such as to a display, a video display unit (e.g., a liquid crystal display (LCD) or a cathode ray tube (CRT)). The computer system 700 may also include a communications interface 726 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms“a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

What is claimed is:

1. A steering module for a marine vessel, comprising:
an inertial measurement unit arranged to measure steering input by monitoring user gestures of a user using the steering module, wherein the user gestures are interpreted as the steering input for steering the marine vessel, and
a control unit arranged to initiate steering of the marine vessel according to the measured steering input.

2. The steering module according to claim 1, wherein the at least one steering module is arranged to be in a connected steering mode or a wireless steering mode.

3. The steering module according to claim 1, wherein the steering module is arranged to provide information indicating an offboard location to a control system comprised in the marine vessel by means of a laser range measurement system comprised in the steering module when the steering module is pointed at the offboard location, wherein the offboard location is offboard the marine vessel.

4. The steering module according to claim 1, comprising a steering module compass and/or a steering module gyro arranged to align the steering input with a vessel compass and/or a vessel gyro comprised in the marine vessel, such that a movement of the steering module is interpreted in a coordinate system of the marine vessel, regardless of user orientation of the user using the steering module.

5. The steering module according to claim 1, wherein the steering module is arranged to be in a neutral state which causes the marine vessel to operate in dynamic position state.

6. The steering module according to claim 1 wherein the steering module is a tiller, a handlebar, a joystick or a steering wheel.

7. The steering module according to claim 1, wherein the steering module is arranged to be comprised in a steering system for the marine vessel together with a control console.

8. A steering system for a marine vessel, comprising:
a control console arranged to be mechanically connected to the marine vessel, wherein the control console comprises a steering module interface; and
at least one steering module arranged to be connected to the control console via the steering module interface;
wherein the at least one steering module is arranged to be selected from a plurality of different steering module types;
wherein the steering module interface is arranged to connect steering modules of different types to the control console; and
wherein the steering system is arranged to steer the marine vessel based on steering input obtained via the at least one steering module.

9. The steering system according to claim 8, wherein the at least one steering module is mechanically connected to the control console via the steering module interface when the at least one steering module is in a connected steering mode; and
wherein the at least one steering module is wirelessly connected to the control console via the steering module interface when the at least one steering module is in a wireless steering mode.

10. The steering system according to claim 8, wherein the steering system is arranged to steer the marine vessel based on the steering input by providing control commands to at least one of a rudder system and/or a propulsion system comprised in the marine vessel.

11. The steering system according to claim 8, wherein a force sensor is connected to a rudder system comprised in the marine vessel and arranged to measure a rudder force, and
wherein an actuator is arranged to apply force feedback to the at least one steering module in dependence of the measured rudder force.

12. The steering system according to claim 8, wherein the control console is arranged to be tilted laterally with respect to a travelling direction of the marine vessel.

13. The steering system according to claim 8, wherein the different types of steering modules comprise one or more of: a tiller, a handlebar, a joystick and a steering wheel.

14. A computer system comprising a processor device configured to:
obtain information indicating measured steering input which has been measured by an inertial measurement unit by monitoring user gestures of a user using the steering module, wherein the user gestures are interpreted as the steering input for steering the marine vessel, and to initiate steering of the marine vessel according to the information indicating the measured steering input, thereby steering the marine vessel according to the user gestures.

15. A computer-implemented method comprising:
obtaining, by a processor device of a computer system, information indicating steering input which has been measured by a six-axes inertial measurement unit by monitoring user gestures of a user using a steering module, wherein the user gestures are interpreted as the steering input for steering the marine vessel, and initiating, by the processor device, steering of the marine vessel according to the information indicating the steering input, thereby steering the marine vessel according to the user gestures.

16. The method according to claim 15, comprising:
obtaining, by the processor device, information indicating that that the steering module is pointed at an offboard location; and initiating, by the processor device, steering of the marine vessel towards the offboard location and/or measuring a distance to the offboard location, wherein the offboard location is offboard the marine vessel.

17. The method according to claim 15, comprising:
determining, by the processor device, that the steering module is in neutral state; and
initiating, by the processor device, the marine vessel to operate in dynamic position state when the steering module is in neutral state.

18. A marine vessel comprising a steering system according to claim 8.

19. A marine vessel comprising at least one steering module according to claim 1.

20. A computer program product comprising program code for performing, when executed by a processor device, the method of claim 14.

21. A control system comprising one or more control units configured to perform the method of claim 14.

22. A non-transitory computer-readable storage medium comprising instructions, which when executed by a processor device, cause the processor device to perform the method of claim 14.
